(19) United States
(12) Patent Application Publication
(10) Pub. No.: US 2012/0297117 A1
(43) Pub. Date: Nov. 22, 2012

(54) DATA STORAGE DEVICE AND DATA MANAGEMENT METHOD THEREOF

(76) Inventors: Han-Chan Jo, Yongin-si (KR); Nam-Oh Hwang, Seoul (KR)

(21) Appl. No.: 13/443,313

(22) Filed: Apr. 10, 2012

(30) Foreign Application Priority Data
May 18, 2011 (KR) 1020110046957

(51) Int. Cl. G06F 12/00

(52) U.S. Cl. 711/103; 711/E12.008

(57) ABSTRACT

Disclosed is a data managing method of a storage device including a nonvolatile memory device. The data managing method includes detecting an update count of update-requested page data and allocating the update-requested page data to a first memory block or a second memory block based upon the update count, an erase count of the second memory block being different from that of the first memory block.

### CROSS-REFERENCE TO RELATED APPLICATION

This application claims priority under 35 U.S.C. §119 to Korean Patent Application No. 10-2011-0046957, filed on May 18, 2011, in the Korean Intellectual Property Office (KIPO), the entire contents of which is incorporated herein by reference.

### BACKGROUND

Example embodiments relate to a semiconductor memory device. For example, example embodiments relate to a storage device and a data managing method thereof.

Semiconductor memory devices may be mainly classified into volatile memory devices and nonvolatile memory devices. Read and write speeds of the volatile memory devices may be fast, while contents stored therein may be lost at power-off. The nonvolatile memory devices may retain contents stored therein even at power-off. For this reason, the nonvolatile memory devices may be used to store contents to be retained regardless of whether they are powered. For example, among the nonvolatile memory devices, a flash memory may be suitable for an application to an auxiliary mass storage device because the integrity of the flash memory may be higher than a typical EEPROM.

Erase and write units of the flash memory may be different from each other. Software called “Flash Translation Layer” (FTL) may be used to overcome problems caused due to a difference between erase and write units. An important function of the FTL may be an address mapping function. The FTL may translate a logical address LA from a host into a physical address PA. Herein, the physical address PA may be an address to be used actually at the flash memory.

As representative address mapping methods, page mapping, block mapping, and hybrid mapping may be used. The page mapping may necessitate a page mapping table. The page mapping table may be used to perform a mapping operation by the page and may store logical addresses and physical addresses each corresponding to the logical addresses. The block mapping may necessitate a block mapping table. The block mapping table may be used to perform a mapping operation by the block and may store memory blocks and physical blocks each corresponding to the memory blocks. The hybrid mapping may be an address mapping method for using the page mapping with the block mapping.

### SUMMARY

One aspect of example embodiments of inventive concepts may be directed to providing a data managing method of a storage device including a nonvolatile memory device, including detecting an update count of update-requested page data; and allocating the update-requested page data to a first memory block or a second memory block based upon the update count, an erase count of the second memory block being different from that of the first memory block.

Another aspect of example embodiments of the inventive concepts may be directed to providing a data storage device including a nonvolatile memory device; and a memory controller configured to allocate update-requested page data to a first memory block or a second memory block based upon an update count of the update-requested page data, an erase count of the second memory block being different from that of the first memory block.

Another aspect of example embodiments of the inventive concepts may be directed to providing a data managing method of a storage device including a nonvolatile memory device, including detecting an update count and an erase count; and allocating page data to a memory block based on at least one of the update count and the erase count.

### BRIEF DESCRIPTION OF THE DRAWINGS

Example embodiments will be more clearly understood from the following brief description taken in conjunction with the accompanying drawings. FIGS. 1-11 represent non-limiting, example embodiments as described herein.

FIG. 1 is a diagram illustrating a software layer structure of a user device according to an example embodiment of the inventive concepts.

FIG. 2 is a block diagram illustrating a user device according to an example embodiment of the inventive concepts.

FIG. 3 is a block diagram illustrating a nonvolatile memory device in FIG. 2 according to an example embodiment of the inventive concepts.

FIG. 4 is a diagram illustrating a page data structure according to an example embodiment of the inventive concepts.

FIG. 5 is a diagram for describing a mapping method according to an example embodiment of the inventive concepts.

FIG. 6 is a flowchart for describing an address mapping method according to an example embodiment of the inventive concepts.

FIG. 7 is a flowchart for describing an operation S140 in FIG. 5 in detail.

FIG. 8 is a block diagram illustrating a user device including a solid state drive according to an example embodiment of the inventive concepts.

FIG. 9 is a block diagram illustrating a memory system according to an example embodiment of the inventive concepts.

FIG. 10 is a block diagram illustrating a data storage device according to an example embodiment of the inventive concepts.

FIG. 11 is a block diagram illustrating a computing system including a memory system according to an example embodiment of the inventive concepts.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION

Example embodiments will now be described more fully with reference to the accompanying drawings, in which example embodiments are shown. Example embodiments may, however, be embodied in many different forms and should not be construed as being limited to the embodiments set forth herein; rather, these embodiments are provided so that this disclosure will be thorough and complete, and will fully convey the concept of example embodiments to those of ordinary skill in the art. In the drawings, the thicknesses of layers and regions are exaggerated for clarity. Like reference numerals in the drawings denote like elements, and thus their description will be omitted.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Like numbers indicate like elements throughout. As used herein the term “and/or” includes any and all combinations of one or more of the associated listed items. Other words used to describe the relationship between elements or layers should be interpreted in a like fashion (e.g., “between” versus “directly between,” “adjacent” versus “directly adjacent,” “on” versus “directly on”).

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “includes” and/or “including,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle may have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

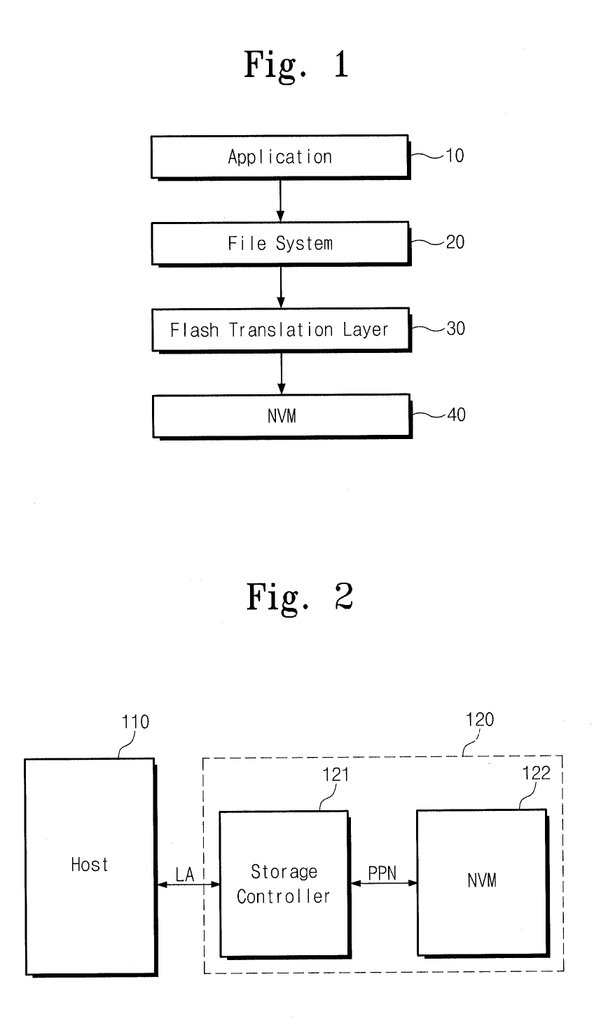

An example embodiment according to the present invention will now be described with reference to FIG. 1. In this example embodiment, FIG. 1 is a diagram illustrating a software layer structure of a user device. Referring to FIG. 1, software of a user device may include an application 10, a file system 20, a flash translation layer 30, and a nonvolatile memory device 40.

In the software layer structure, the application 10 and the file system 20 may be classified into an operating system OS. The file system 20 may be defined by a set of abstract data structures for hierarchically storing, searching, accessing, and operating data.

The flash translation layer (FTL) 30 may provide an interface between the file system 20 and the nonvolatile memory device 40 to hide an erase operation of the nonvolatile memory device 40. The FTL 30 may make up for drawbacks of the nonvolatile memory device 40 due to erase-before-write and a mismatch between erase and write units. The FTL 30 may map a logical address LA generated by the file system 20 onto a physical address PA of the nonvolatile memory device 40.

The FTL 30 may map a logical address LA provided from the file system 20 onto a logical page address LPN according to a page mapping manner. The logical page address LPN may be mapped onto a physical page address PPN. For example, according to an example embodiment of the inventive concepts the FTL 30 may assign page data to a memory block according to an update count. It is possible to manage frequently updated pages using the same memory block.

The write performance may be important for a storage device using a nonvolatile memory device such as a NAND flash memory. For example, the write performance of frequently updated data such as metadata may be important. For example, flexible and efficient compactions (e.g., garbage collection, a merge operation, etc.) for coping with various situations may be required to control a NAND flash memory used as a storage device for a server. The FTL driven at a storage device for a server may use a page mapping manner.

For efficient compaction and wear leveling of a storage device using the page mapping manner, block allocation may be made considering an update count of page data. For example, under the control of the FTL 30, page data with a high update frequency may be allocated collectively at a memory block whose erase count value is low. On the other hand, page data with a low update frequency may be allocated collectively at a memory block whose erase count value is high. The probability that page data having a large update count value is copied to another block by a merge operation may be high in proportion to a level of an update count value. On the other hand, the probability that page data having a small update count value is copied to another block by a merge operation may be low in proportion to a level of an update count value. Accordingly, it is possible to make wear leveling efficiently.

FIG. 2 is a block diagram illustrating a user device according to an example embodiment of the inventive concepts. Referring to FIG. 2, a user device 200 may include a host 110 and a storage device 120. The storage device 120 may include a storage controller 121 and a nonvolatile memory device 122.

Upon a write request, the host 110 may transfer write data and a logical address LA to the storage device 120. In the event that the user device 100 is a personal computer or a notebook computer, the logical address LA may be transferred by the sector. For example, at a write request, the host 110 may provide the storage device 120 with a sector count nSC and a start address LBA for writing data.

The storage device 120 may be configured to store write data transferred from the host 110. The storage controller 121 may be configured to interface with the host 110 and the nonvolatile memory device 122. The storage controller 121 may control the nonvolatile memory device 122 in response to a write command such that data from the host 110 may be written in the nonvolatile memory device 122. The storage controller 121 may control the nonvolatile memory device 122 in response to a read command from the host 110.

The nonvolatile memory device 122 may include software (or, firmware) such as a flash translation layer (FTL). The FTL may provide an interface between a file system of the host 110 and the nonvolatile memory device 122 to hide an erase operation of the nonvolatile memory device 122. The FTL may make up for drawbacks of the nonvolatile memory device 122 due to erase-before-write and a mismatch between erase and write units. At a write operation of the nonvolatile memory device 122, the FTL 30 may map a logical address LA generated by a file system onto a physical address PPN of the nonvolatile memory device 122.

The FTL may be driven by the storage controller 121 and may conduct address mapping. The FTL may map a logical address (e.g., a sector address) provided from the host 110 onto a page address PPN being a physical address of the nonvolatile memory device 122. The FTL may assign pages to memory blocks according to attributes.

For example, the FTL may assign page data of a high update frequency to a hot block. The FTL may assign page data of a low update frequency to a cold block. Page data assigned to the hot block may frequently experience page copying due to garbage collection or a merge operation. On the other hand, page data assigned to the cold block may occasionally experience page copying due to compaction. Accordingly, if a block having a large erase count is assigned to a cold block, active wear leveling may be made.

The nonvolatile memory device 122 may perform an erase operation, a read operation, or a write operation under the control of the storage controller 121. The nonvolatile memory device 122 may include a plurality of memory blocks, each of which may have a plurality of pages. In the event that a plurality of nonvolatile memory devices are connected with the storage controller 121 via at least two channels, the performance of the nonvolatile memory device 122 may be improved by a memory interleaving manner.

One channel may be connected with a plurality of memory devices that may be connected with the same data bus. It may be assumed that a memory device includes a NAND flash memory as a storage medium. However, the example embodiment of the inventive concepts is not limited thereto. For example, a PRAM, MRAM, ReRAM, FRAM, NOR flash memory, etc. may be used as a storage medium. Example embodiments of the inventive concepts may be applied to a memory system that includes different memory devices. Further, a volatile memory device (e.g., DRAM) may be included as a storage medium.

With the above description, according to an example embodiment of the inventive concepts the storage device 120 may be configured to assign page data to different memory blocks according to an update count. For example, page data with a low update frequency may be assigned to a memory block having a large erase count, and page data with a high update frequency may be assigned to a memory block having a small erase count. It may be possible to reduce a difference between erase counts of memory blocks in the nonvolatile memory device 122 and to improve the efficiency of wear leveling. This means that the lifetime of the storage device 100 may be extended.

Example embodiments of the inventive concepts may be applied to a storage device such as a solid state driver (SSD). The storage controller 121 may be configured to communicate with the host 110 via one or more of the interface protocols, e.g. USB, MMC, PCI-E, SATA, PATA, IDE, E-IDE, SCSI, ESDI, SAS, and the like.

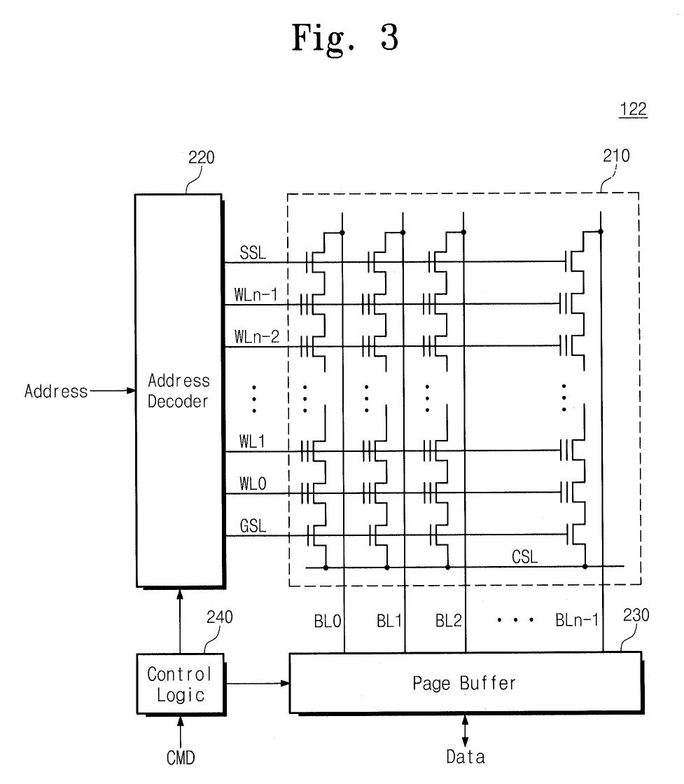

FIG. 3 is a block diagram illustrating a nonvolatile memory device in FIG. 2 according to an example embodiment of the inventive concepts. Referring to FIG. 3, a nonvolatile memory device 122 may include a cell array 210, an address decoder 220, a page buffer 230, and control logic 240.

The cell array 210 may include a plurality of memory blocks. For ease of description, an example memory block in the cell array 210 is shown in FIG. 2. Each of the memory blocks may include a plurality of pages, each of which may be made up of a plurality of memory cells. In the nonvolatile memory device 122, an erase operation may be performed by the memory block and a write and a read operation may be made by the page. Each of the pages may include a user data region and a spare data region. The spare data region in each page may be used to store an update count UP_CNT of page data corresponding thereto.

The cell array 210 may include a plurality of memory cells. The memory cells may be arranged to form a cell string structure. One cell string may include a string selection transistor SST connected with a string selection line SSL, a plurality of memory cells each connected with a plurality of word lines WL0 to WLn−1, and a ground selection transistor GST connected with a ground selection line GSL. The string selection transistor SST may be connected with a bit line BL, and the ground selection transistor GST may be connected with a common source line CSL.

The memory cells of the cell array 210 may be implemented by a memory cell having a charge storage layer, such as a floating gate or a charge trap layer, or a memory cell having a variable resistance element. The cell array 210 may be implemented to have a single-layer array structure (or, called a two-dimensional array structure) or a multi-layer array structure (or, called a vertical-type or stack-type three-dimensional array structure.

The address decoder 220 may be coupled with the cell array 210 via selection lines SSL and GSL or word lines WL0 to WLn−1. At programming or reading, the address decoder 220 may select a word line (e.g., WL1) in response to an address. The address decoder 220 may be configured to supply voltages needed for programming to selected word lines or voltages needed for reading to unselected word lines.

The page buffer 230 may operate a write driver or a sense amplifier. The page buffer 230 may be configured to temporarily store data to be programmed in selected memory cells or data read out from the selected memory cells. The page buffer 230 may be coupled with the cell array 210 via bit lines BL0 to BLm−1. At programming, the page buffer 230 may transfer input data to memory cells of a selected page. At reading, the page buffer 230 may read data from the memory cells of the selected page to output the data to an external device.

The control logic 240 may control a whole operation (e.g., programming, erasing, reading, etc.) of the nonvolatile memory device 122 according to a command from the external device or the control of the external device. For example, at programming, the control logic 240 may control the address decoder 220 to supply a program voltage to a selected word line. The control logic 240 may control the page buffer 230 such that program data may be provided to a selected page.

An update count UP_CNT of page data stored in each row may be output to the external device under the control of the control logic 240.

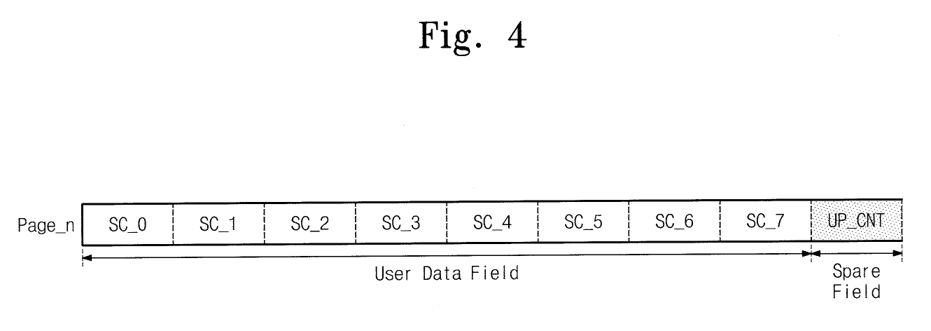

FIG. 4 is a diagram illustrating a page data structure according to an example embodiment of the inventive concepts. Referring to FIG. 4, one page data Page_n may include a plurality of sectors SC_0 to SC_7 and an update count UP_CNT.

A nonvolatile memory device 122 may include a plurality of memory spaces. For example, data may be written or read by the page. A memory space, that is, a page may include sectors each having a size defined by a user. A sector size may be determined variously. For example, a sector may be set to have a size of 1 Kbyte. The update count UP_CNT may be stored in a spare region in which control information such as metadata is stored.

According to an example embodiment of the inventive concepts, a page may include a field in which a page update count may be stored. If an update on a specific sector is requested from a host 110, a storage controller 121 may update a page including an update-requested sector. Accordingly, a page before updating may be marked to be invalid, and a page including an updated sector may be programmed at another page location in a block.

Upon an access request from the host 110, the storage controller 121 may make block allocation on a selected page based upon an update count UP_CNT of the selected page. For example, if the update count UP_CNT of the selected page is below a reference value, the storage controller 121 may classify the selected page into a group including pages of a low update frequency. Such a page may be called a cold page. Cold pages may be allocated to a memory block having a large erase count. Page data classified into the cold page may have a low update frequency stochastically. Accordingly, if cold pages are assigned to a memory block having a large erase count, the merge or garbage collection probability on the memory block may lower. This means a decrease in the probability that an erase count of a memory block increases.

In the event that the update count UP_CNT of the selected page is over the reference value, the storage controller 121 may classify the selected page into a group of pages each having a high update frequency. Such a page may be called a hot page. Hot pages may be allocated to a memory block having a small erase count. Page data classified into the hot page may have a high update frequency like metadata. Accordingly, if hot pages are written in a memory block having a small erase count, the merge or garbage collection probability on the memory block may become high. In other words, a memory block to which hot pages are assigned may experience frequent page copying and erasing. This means that an erase count of a memory block increases.

There was described the case that pages are classified into a hot page and a cold page according to an update count UP_CNT. However, example embodiments of the inventive concepts are not limited thereto. For example, page attribute may be divided into three or more levels according to the update count UP_CNT.

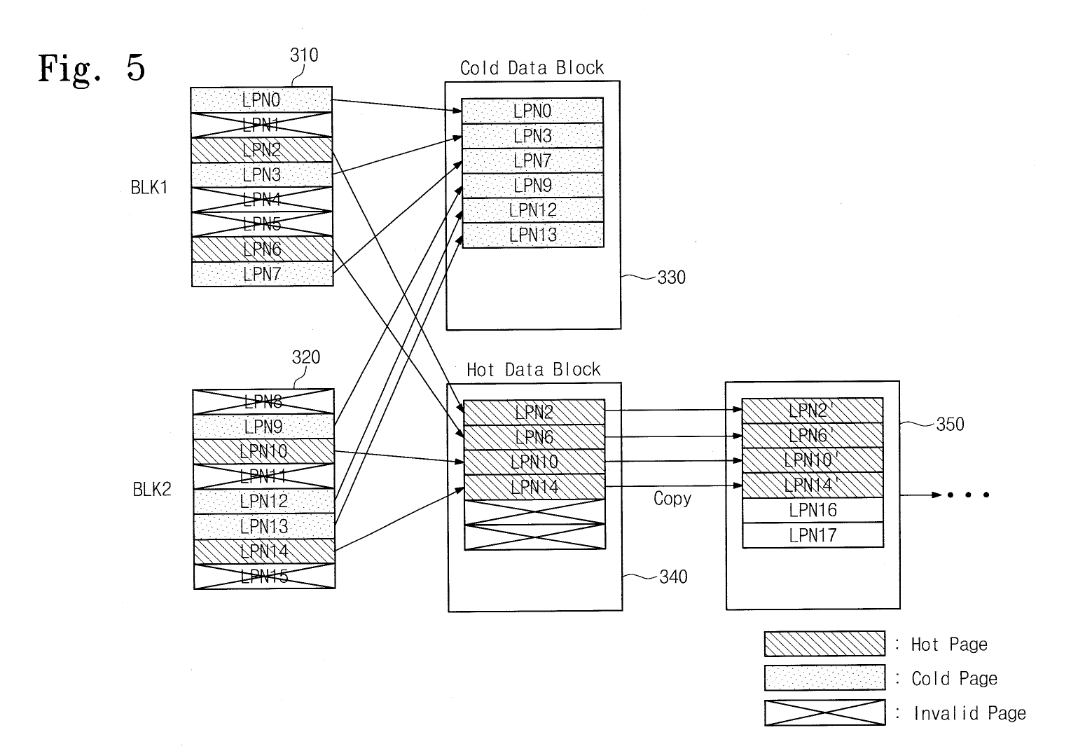

FIG. 5 is a diagram for describing a mapping method according to an example embodiment of the inventive concepts. Below, the mapping method according to the example embodiment of the inventive concepts will be more fully described using a block allocation procedure of pages LPN1 to LPN7 and LPN8 to LPN15 written in two memory blocks BLK1 and BLK2.

If an access to pages stored in the first memory block 310 is requested, a storage controller 121 may detect an update count UP_CNT that may be managed by a spare region or by a table on a working memory. It may be assumed that the storage controller 121 classifies pages LPN0, LPN3, LPN7, LPN9, LPN12, and LPN13 to a cold page and pages LPN2, LPN6, LPN10, and LPN14 to a hot page.

Invalid pages LPN1, LPN4, LPN5, LPN8, LPN11, and LPN15 may be data that is treated to be invalid by an update operation. Page copying on the invalid pages LPN1, LPN4, LPN5, LPN8, LPN11, and LPN15 may not be executed.

Each of cold pages LPN0, LPN3, LPN7, LPN9, LPN12, and LPN13 may be copied to a cold data block 330 at a point in time when access is requested from a host 110. Alternatively, the cold pages LPN0, LPN3, LPN7, LPN9, LPN12, and LPN13 may be simultaneously copied to the cold data block 330 when the memory blocks 310 and 320 are merged.

The resulting update probability on the cold pages LPN0, LPN3, LPN7, LPN9, LPN12, and LPN13 copied to the cold data block 330 may be low. Although time elapses, the probability that the cold pages LPN0, LPN3, LPN7, LPN9, LPN12, and LPN13 are maintained within the cold memory block 330 without updating may be high. On the other hand, hot pages LPN2, LPN6, LPN10, and LPN14 copied to a hot data block 340 may be continuously copied to another hot data block 350 by a merge operation.

If page data is managed according to the above-described manner, erase counts of memory blocks in a nonvolatile memory device may be maintained uniformly.

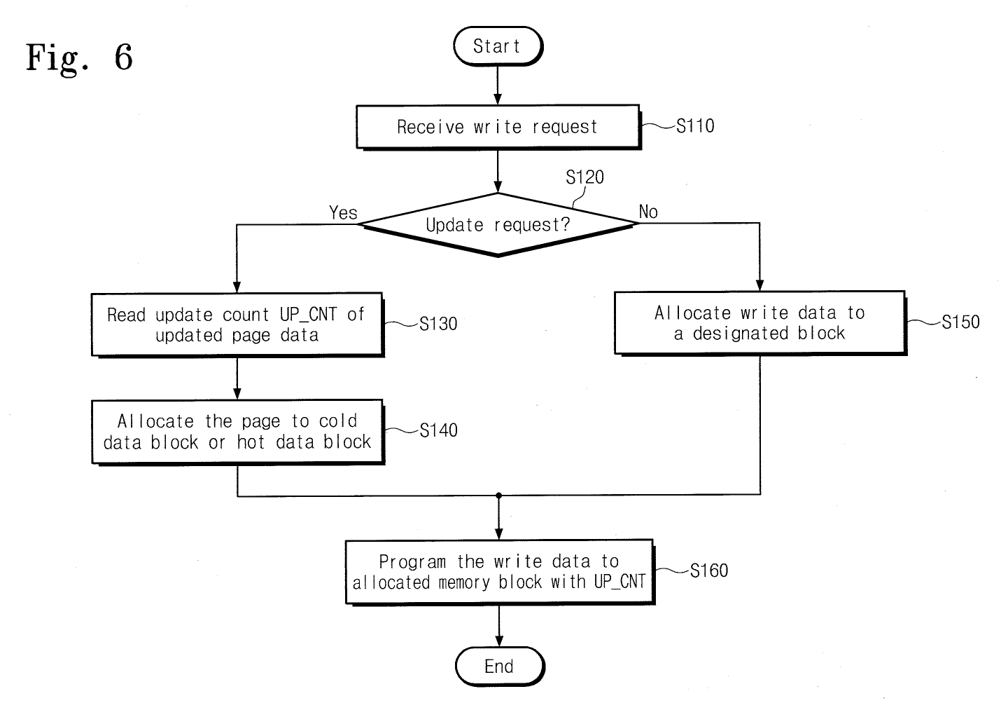

FIG. 6 is a flowchart for describing an address mapping method according to an example embodiment of the inventive concepts. If an access to a nonvolatile memory device 120 is requested from a host 110, a page mapping operation of a storage controller 121 may commence.

In operation S110, the storage controller 121 or a flash translation layer 30 (refer to FIG. 1) may receive a write request from the host 110. The write request may include write-requested data and a logical address corresponding thereto.

In operation S120, the storage controller 121 may judge whether the write request is an update request or a write request on new data. If the write request is an update request, the method proceeds to operation S130, in which an update count UP_CNT on a target page may be read. If the write request is a write request on new data, the method proceeds to operation S150, in which the write data may be assigned to a designated memory block.

In operation S130, the storage controller 121 may read an update count UP_CNT on at least one update-requested page. The update count UP_CNT may be stored in a spare field of a cell array 210 in which a page to be updated is to be stored. The storage controller 121 may acquire an update count included in page data to be updated by reading a page to be updated. Alternatively, the update count UP_CNT may be stored in a look-up table on a working memory of the storage controller 121. The update count UP_CNT may be acquired by scanning the look-up table.

In operation S140, the storage controller 121 may allocate page data to a memory block depending upon the acquired update count UP_CNT. If the acquired update count UP_CNT is over a reference value, the storage controller 121 may allocate the write-requested page data to a hot data block. If the acquired update count UP_CNT is below the reference value, the storage controller 121 may allocate the write-requested page data to a cold data block. If block allocation using the update count UP_CNT may be completed, the method may proceed in operation S160, in which write data is programmed in the allocated memory block by the page.

Returning to operation S150, if the write request is judged not to be an update request, the storage controller 121 may allocate the write data to a memory block selected according to a page mapping manner. Typically, the case that the write request is judged not to be an update request may include an input of new data, a write request on mass data, and the like. The method may proceed to operation S160.

In operation S160, the storage controller 121 may write the write-requested data in a nonvolatile memory device 122 by the page. Page data assigned to the cold or hot data block may be stored in a selected page region together with an increased update count UP_CNT. In the event that write data is not update data, such as an input of new data, an initial value may be recorded at an update count field. If programming on the write-requested data is completed, the method may be ended.

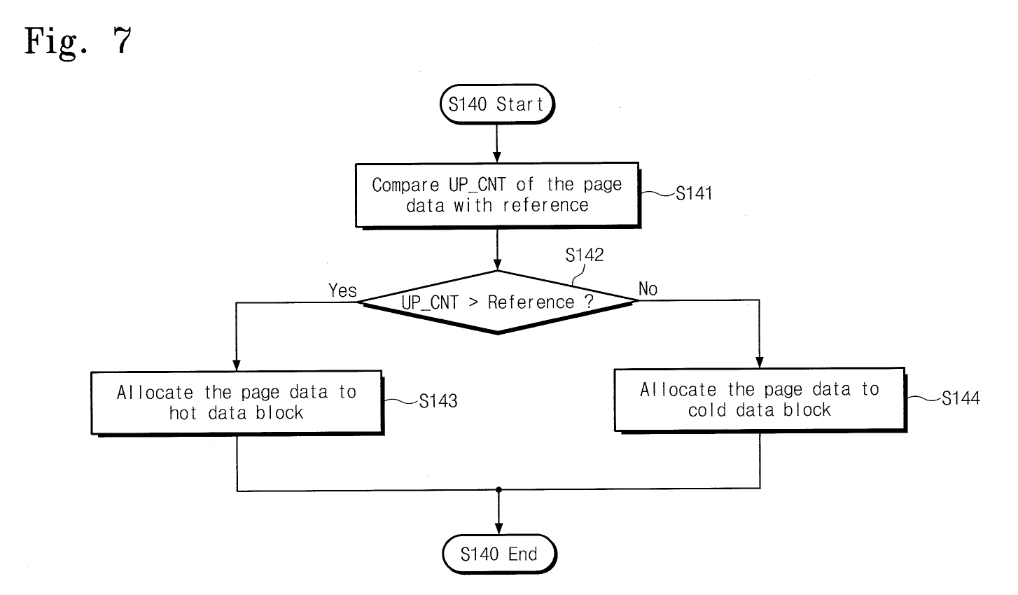

FIG. 7 is a flowchart for describing an operation S140 in FIG. 5 in detail. Block allocation on write-requested data may be made depending upon an update count UP_CNT.

In operation S141, an acquired update count UP_CNT may be compared with a reference value. The reference value may be determined in various ways. For example, the reference value may be determined fixedly or variably according to page locations, memory characteristics, an average value of a whole erase count, and the like.

In operation S142, if the acquired update count UP_CNT of a selected page is over the reference value, the procedure may go to operation S143, in which write-requested data is assigned to a hot data block. If the acquired update count UP_CNT of a selected page is below the reference value in operation S142, the procedure may go to operation S144, in which write-requested data is assigned to a cold data block.

It is possible to reduce a page copying number due to a merge operation or garbage collection by assigning write-requested page data to a memory block according to the above-described manner. As an erase count of a memory block increases, the probability that the memory block is allocated to a cold data block may be high. Accordingly, a difference between erase counts may be reduced by allocating a memory block having a small erase count to a hot data block. This may enable the wear leveling efficiency to be improved. In other words, the lifetime of the nonvolatile memory device may be extended.

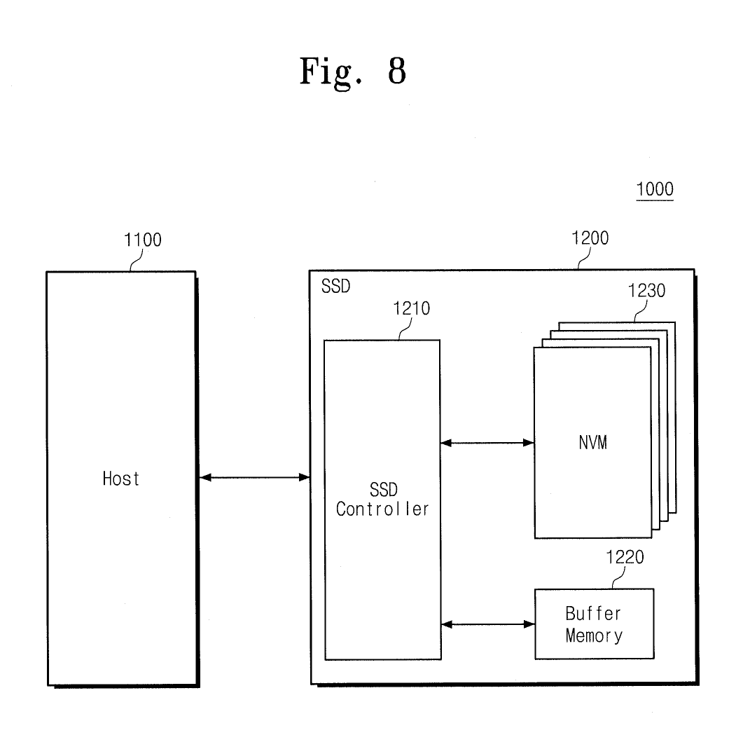

FIG. 8 is a block diagram illustrating a user device including a solid state drive according to an example embodiment of the inventive concepts. Referring to FIG. 8, a user device 1000 may include a host 1100 and an SSD 1200. The SSD 1200 may include an SSD controller 1210, a buffer memory 1220, and a nonvolatile memory device 1230.

The SSD controller 1210 may provide physical interconnection between the host 1100 and the SSD 1200. The SSD controller 1210 may provide an interface with the SSD 1200 corresponding to a bus format of the host 1100. For example, the SSD controller 1210 may decode a command provided from the host 1100. The SSD controller 1210 may access the nonvolatile memory device 1230 according to the decoding result. The bus format of the host 1100 may include USB (Universal Serial Bus), SCSI (Small Computer System Interface), PCI express, ATA, PATA (Parallel ATA), SATA (Serial ATA), SAS (Serial Attached SCSI), and the like.

The SSD controller 1210 may generate an update count UP_CNT upon writing of write-requested data from the host 110. The update count UP_CNT may be stored in a spare region of the nonvolatile memory device 1230 or in a look-up table on a working memory. The update count UP_CNT may increase whenever an update on written page data is requested.

Upon a write request, the SSD controller 1210 may allocate write-requested page to a hot data block or a cold data block based upon the update count UP_CNT. Page data assigned to the hot data block may be updated and merged frequently. On the other hand, the copying probability due to a merge operation may be low on page data assigned to the cold data block. Accordingly, a memory block having a large erase count may be assigned to a cold data block and a memory block having a small erase count may be assigned to a hot data block. A difference of erase counts of memory blocks may be reduced and the wear leveling efficiency of a memory device may be improved.

The buffer memory 1220 may temporarily store write data provided from the host 1100 or data read out from the nonvolatile memory device 1230. In the event that data existing in the nonvolatile memory device 1230 is cached at a read request of the host 1100, the buffer memory 1220 may support a cache function of providing cached data directly to the host 1100. Typically, a data transfer speed of a bus format (e.g., SATA or SAS) of the host 1100 may be higher than that of a memory channel of the SSD 1200. For example, in the event that an interface speed of the host 1100 is remarkably fast, lowering of the performance due to a speed difference may be minimized by providing the buffer memory 1220 having a large storage capacity.

The buffer memory 1220 may include a synchronous DRAM to provide sufficient buffering to the SSD 1200 used as an auxiliary mass storage device. However, the buffer memory 1220 is not limited to this disclosure.

The nonvolatile memory device 1230 may be provided as a storage medium of the SSD 1200. For example, the nonvolatile memory device 1230 may include a NAND flash memory device having a mass storage capacity. The nonvolatile memory device 1230 may include a plurality of memory devices. Memory devices may be connected with the SSD controller 1210 by a channel unit. The nonvolatile memory device 1230 is not limited to a NAND flash memory device. For example, a PRAM, an MRAM, a ReRAM, a FRAM, a NOR flash memory, etc. may be used as a storage medium of the SSD 1200. Further, example embodiments of the inventive concepts may be a memory system that uses different types of memory devices together. A volatile memory device (e.g., DRAM) may be used as a storage media.

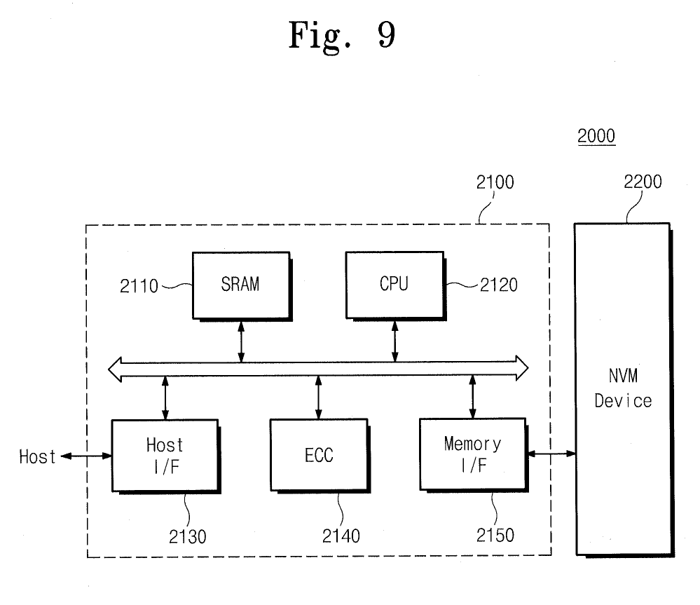

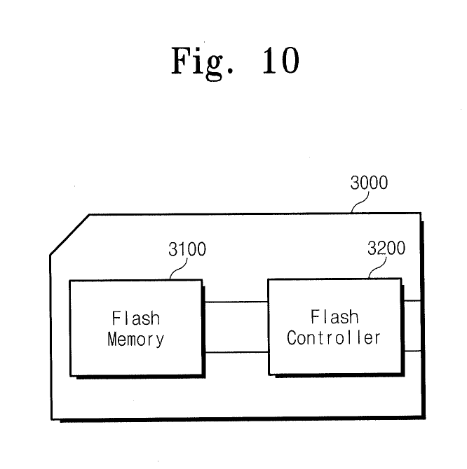

FIG. 9 is a block diagram illustrating a memory system according to an example embodiment of the inventive concepts. Referring to FIG. 9, a memory system 2000 may include a memory controller 2100 and a nonvolatile memory device 2200.

The memory controller 2100 may be configured to control the nonvolatile memory device 2200. The nonvolatile memory device 2200 and the memory controller 2100 may constitute a memory card or a solid state drive (SSD). An SRAM 2110 may be used as a working memory of a CPU 2120. Herein, a loop-up table including update counts of page data may be stored in the SRAM 2110.

A host interface 2130 may include a data exchange protocol of a host connected with the memory system 2000. An ECC block 2140 may be configured to detect and correct errors included in data read out from the nonvolatile memory device 2200. A memory interface 2150 may interface with the nonvolatile memory device 2200 according to an example embodiment of the inventive concepts. The CPU 2120 may execute an overall control operation for data exchange of the memory controller 2100. Although not shown in FIG. 9, the memory system 2000 may further include ROM that stores code data for interfacing with the host.

Upon a write request, the memory controller 2100 may allocate write-requested page to a hot data block or a cold data block based upon an update count UP_CNT. Page data assigned to the hot data block may be updated and merged frequently. On the other hand, the copying probability due to a merge operation may be relatively low on page data assigned to the cold data block. Accordingly, a memory block having a large erase count may be assigned to a cold data block and a memory block having a small erase count may be assigned to a hot data block. A difference of erase counts of memory blocks may be reduced and the wear leveling efficiency of a memory device may be improved.

The nonvolatile memory device 2200 may be implemented by a multi-chip package including a plurality of flash memory chips. The memory system 2000 may be provided as a storage medium having high reliability and a low error generation probability. The memory controller 2100 may communicate with an external device via one of interface protocols such as USB, MMC, PCI-E, SAS, SATA, PATA, SCSI, ESDI, IDE, and the like.

FIG. 10 is a block diagram illustrating a data storage device according to an example embodiment of the inventive concepts. Referring to FIG. 10, a data storage device 3000 may include a flash memory 3100 and a flash controller 3200. The flash controller 3200 may control the flash memory 3100 in response to control signals input from the outside of the data storage device 3000.

Upon a write request, the memory controller 2100 may allocate write-requested page to a hot data block or a cold data block based upon an update count UP_CNT. Page data assigned to the hot data block may be updated and merged frequently. On the other hand, the copying probability due to a merge operation may be relatively low on page data assigned to the cold data block. Accordingly, a memory block having a large erase count may be assigned to a cold data block and a memory block having a small erase count may be assigned to a hot data block. A difference of erase counts of memory blocks may be reduced and the wear leveling efficiency of a memory device may be improved.

The data storage device 3000 may be a memory card device, an SSD device, a multimedia card device, an SD device, a memory stick device, a HDD device, a hybrid drive device, or an USB flash device. For example, the data storage device 3000 may be a card that satisfies a standard for using a user device such as a digital camera, a personal computer, and the like.

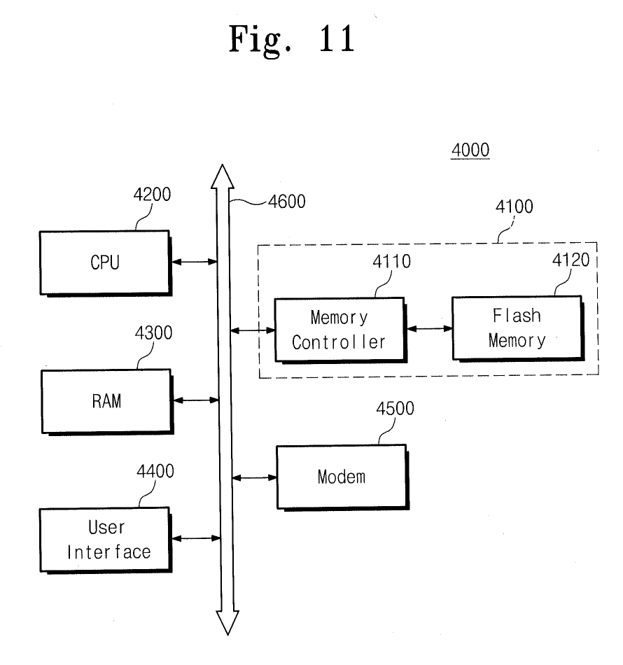

FIG. 11 is a block diagram illustrating a computing system including a memory system according to an example embodiment of the inventive concepts. A computing system 4000 may include a CPU (or, a microprocessor) 4200, a RAM 4300, a user interface 4400, a modem 4500 such as a baseband chipset, and a memory system 4100 which may be electrically connected with a system bus 4600. The memory system 4100 may be configured the same as an SSD in FIG. 8, a memory system in FIG. 9, or a memory card in FIG. 10. The memory system 4100 may include a memory controller 4110 and flash memory 4120.

If the computing system 4000 is a mobile device, it may further include a battery (not shown) that powers the computing system 4000. Although not shown in FIG. 11, the computing system 4000 may further include an application chipset, a camera image processor (CIS), a mobile DRAM, and the like. The memory system 4100 may be a solid state drive/disk (SSD) that uses a nonvolatile memory to store data. Alternatively, the memory system 4100 may include a fusion flash memory (e.g., a One-NAND flash memory).

Upon a write request from the CPU 4200, the memory controller 2100 may allocate write-requested page to a hot data block or a cold data block based upon an update count UP_CNT. Page data assigned to the hot data block may be updated and merged frequently. On the other hand, the copying probability due to a merge operation may be relatively low on page data assigned to the cold data block. Accordingly, a memory block having a large erase count may be assigned to a cold data block and a memory block having a small erase count may be assigned to a hot data block. A difference of erase counts of memory blocks may be reduced and the wear leveling efficiency of a memory device may be improved.

A nonvolatile memory device or a memory controller may be packed by one selected from various types of packages such as PoP (Package on Package), Ball grid arrays (BGAs), Chip scale packages (CSPs), Plastic Leaded Chip Carrier (PLCC), Plastic Dual In-Line Package (PDI2P), Die in Waffle Pack, Die in Wafer Form, Chip On Board (COB), Ceramic Dual In-Line Package (CERDIP), Plastic Metric Quad Flat Pack (MQFP), Thin Quad Flatpack (TQFP), Small Outline (SOIC), Shrink Small Outline Package (SSOP), Thin Small Outline (TSOP), Thin Quad Flatpack (TQFP), System In Package (SIP), Multi Chip Package (MCP), Wafer-level Fabricated Package (WFP), Wafer-Level Processed Stack Package (WSP), and the like.

Using example embodiments of the inventive concepts, memory block mapping may be made according to an update count of page data. Page data of a high update frequency may be assigned to a memory block having a relatively small erase count and page data of a low update frequency may be assigned to a memory block having a relatively large erase count. Accordingly, a difference of erase counts of memory blocks may be reduced and merge or garbage collection efficiency may be improved. This means that a data write operation may be performed at a high speed and the lifetime of a data storage device or a user device including the same is extended.

The above-disclosed subject matter is to be considered illustrative, and not restrictive, and the appended claims are intended to cover all such modifications, enhancements, and other embodiments, which fall within the true spirit and scope. Thus, to the maximum extent allowed by law, the scope is to be determined by the broadest permissible interpretation of the following claims and their equivalents, and shall not be restricted or limited by the foregoing detailed description.

While example embodiments have been particularly shown and described, it will be understood by one of ordinary skill in the art that variations in form and detail may be made therein without departing from the spirit and scope of the claims.

What is claimed is:

1. A data managing method of a storage device including a nonvolatile memory device, comprising:
detecting an update count of update-requested page data; and
allocating the update-requested page data to a first memory block or a second memory block based upon the update count, an erase count of the second memory block being different from that of the first memory block.

2. The data managing method of claim 1, wherein if the update count is over a reference value, the update-requested page data is allocated to the first memory block having an erase count smaller than that of the second memory block.

3. The data managing method of claim 2, wherein the update count is read from a spare field of the nonvolatile memory device.

4. The data managing method of claim 2, wherein the update count is read from a look-up table located outside the nonvolatile memory device.

5. The data managing method of claim 2, further comprising:
receiving a write request by a controller of the storage device; and
judging whether the write request is an update request or not.

6. The data managing method of claim 5, further comprising:
assigning the update-requested page data to a memory block selected by a page address mapping manner when the write request is not the update request.

7. The data managing method of claim 5, further comprising:
when the write request is the update request, counting up the detected update count to write the counted-up update count in the nonvolatile memory device together with the update-requested page data.

8. A data storage device comprising:
a nonvolatile memory device; and
a memory controller configured to allocate update-requested page data to a first memory block or a second memory block based upon an update count of the update-requested page data, an erase count of the second memory block being different from that of the first memory block.

9. The data storage device of claim 8, wherein the update-requested page data is allocated to the second memory block when an erase count of the first memory block is larger than that of the second memory block and the update count is over a reference value.

10. The data storage device of claim 9, wherein the reference value is varied according to at least one of a storage location of the update-requested page data and an average value of erase counts of a memory block.

11. The data storage device of claim 8, wherein the update count is read out from a spare field of the nonvolatile memory device.

12. The data storage device of claim 8, wherein the memory controller includes a working memory configured to store the update count using a look-up table.

13. The data storage device of claim 8, wherein the memory controller includes a flash translation layer configured to translate a logical address provided from an external device to a physical address of the nonvolatile memory device in response to an update request of page data.

14. The data storage device of claim 13, wherein the flash translation layer is configured to convert the logical address into the physical address according to a page address mapping method.

15. The data storage device of claim 8, wherein the nonvolatile memory device and the memory controller constitute a solid state drive.

16. A data managing method of a storage device, comprising:
detecting an update count and an erase count; and
allocating page data to a memory block based on at least one of the update count and the erase count.

17. The data managing method of claim 16, wherein the page data is allocated to a first memory block having an erase count smaller than the erase count of a second memory block.

18. The data managing method of claim 16, wherein the page data is allocated to a memory block if the update count is over a reference value.

19. The data managing method of claim 16, wherein if the update count is over a reference value, the page data is allocated to a first memory block having an erase count smaller than the erase count of a second memory block.

20. The data managing method of claim 16, wherein the update count is read from at least one of a spare field of the nonvolatile memory device and a look-up table located external to the nonvolatile memory device.
